(19) United States
(12) Patent Application Publication
(10) Pub. No.: US 2017/0169420 A1
(43) Pub. Date: Jun. 15, 2017

(54) ONE-STEP PAYMENTS IN A SECURE DIGITAL PLATFORM

(71) Applicant: WIBMO Inc., Cupertino, CA (US)

(72) Inventors: Govindaraj N. Setlur, Cupertino, CA (US); Akshathkumar Shetty, Bangalore (IN)

(21) Appl. No.: 15/377,791

(22) Filed: Dec. 13, 2016

Related U.S. Application Data
(60) Provisional application No. 62/286,942, filed on Jan. 25, 2016.

(30) Foreign Application Priority Data
Dec. 14, 2015 (IN) 6695/CHE/2015

(51) Int. Cl. G06Q 20/32; G06Q 20/40

(52) U.S. Cl. CPC G06Q 20/3229; G06Q 20/40145

(57) ABSTRACT

A digital payments platform allows users to approve and execute digital payment transactions using a mobile wallet application executing on a registered mobile device. Users initiate transactions on a website of a participating online merchant, at a point-of-sale of a participating physical merchant, or within a participating third-party mobile application. For each such payment transaction, a user receives a transaction approval request on the registered mobile device. The user can review the transaction request and approve it by performing a single action (such as a button press).

### RELATED APPLICATIONS

This application claims priority to U.S. provisional application 62/286,942 filed on Jan. 25, 2016 which is incorporated by reference herein in its entirety and Indian application 6695/CHE/2015 filed on Dec. 14, 2015 which is incorporated by reference herein in its entirety.

### FIELD OF ART

This application relates generally to the field of digital payments.

### BACKGROUND

Digital payments have become nearly ubiquitous in recent years. Consumers are increasingly purchasing goods and services over the Internet—and doing so using a wide variety of Internet-enabled devices, such as personal computers, laptops, tablets, and smartphones. However, issues of security and legitimacy are pervasive across the various channels and modes of the digital payments ecosystem. Digital payments—due in part to an open architecture that emphasizes flexibility and versatility—are plagued by fraudulent activity, theft, and loss. The lack of reliability in digital payments technologies discourages consumers from using them extensively in their daily lives.

Fraudulent activity remains a particular problem in developing markets. A persistent lack of confidence in the security of credit and debit cards leads people to avoid using these and other payment instruments to complete online transactions. Moreover, attempts by banks and other financial institutions to improve the security of such payment instruments—whether by additional verification steps or by restrictions on their use—cause users to be inconvenienced and further discouraged from making digital transactions more often.

### SUMMARY

Methods are disclosed by which users can execute digital payment transactions within a secure digital payments platform. Users download and configure a mobile application, also known as a “wallet app”, onto their mobile device (or “smartphone”). Using the mobile application, users register an account with a platform control system of the digital payments platform (or “platform”). Users can also add funds to the mobile application or link payment instruments (debit and credit cards) with which to execute digital payment transactions. Subsequent to successfully registering and configuring the app, a user can use his/her mobile device to approve and execute digital payment transactions in a variety of modes. These modes include but are not limited to: transactions initiated on a website of an online merchant, transactions initiated at a point-of-sale in a physical store, transactions initiated within a third-party mobile application 114 (such as a shopping or e-commerce app), and transactions initiated within the wallet app itself. Regardless of the type of transaction, the platform provides users the unique ability to approve and execute the transaction by performing a single action. Typically, this action involves clicking a button within the mobile application (or “wallet app”). In most embodiments, users do not have to enter any information pertaining to the transaction or a payment instrument at the time of purchase, greatly simplifying the digital transaction process.

Before processing a transaction, the platform control server of the digital payments platform verifies information identifying the user and his/her registered mobile device. This information may include a PIN provided by the user, information describing a SIM card installed on the user's registered mobile device, and/or information describing the registered mobile device itself. Information transmitted by the mobile application to the platform control system is protected using one or more cryptographic techniques, including symmetric and asymmetric encryption algorithms.

The digital payments platform cooperates with various participants of the payments ecosystem. This ecosystem includes merchants (both physical and e-commerce) and banks (and other financial institutions which issue payment instruments). Merchants enable themselves to accept digital transactions over the digital platform by integrating software components, such as a Web SDK, into their website (in the case of an e-commerce merchant) and/or implementing hardware and software equipment, such as a smartphone device or a modified point-of-sale (POS) device, at a physical point of sale (in the case of a physical merchant). Banks, and other issuers of payment instruments, enable themselves to participate in the digital payments platform by configuring software and/or hardware equipment to receive and verify transaction information sent by the platform control system of the digital payments platform.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a digital payment platform, according to one embodiment.

FIG. 2 is a diagram illustrating a client mobile application of a digital payment platform, according to one embodiment.

FIG. 3 is a flowchart illustrating a process for registering a user with the digital payments platform, according to one embodiment.

FIG. 4 is a flowchart illustrating the process of completing a single-action payment transaction via a website of an online merchant, according to one embodiment.

FIG. 5 is a diagram illustrating the process of completing a single-action payment transaction via a website of an online merchant, according to one embodiment.

FIG. 6 is a flowchart illustrating the process of completing a single action payment transaction at a physical point of sale, according to one embodiment.

FIG. 7 is a diagram illustrating the process of completing a single action payment transaction at a physical point of sale, according to one embodiment.

FIG. 8 is a flowchart illustrating the process of completing a single action payment transaction within a third-party mobile application, according to one embodiment.

FIG. 9 is a diagram illustrating the process of completing a single action payment transaction within a third-party mobile application, according to one embodiment.

FIG. 10 is a flowchart illustrating the process of completing a single action payment transaction within a client mobile application, according to one embodiment.

FIG. 11 is a diagram illustrating the process of completing a single action payment transaction within a client mobile application, according to one embodiment.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Environment of a Digital Payments Platform

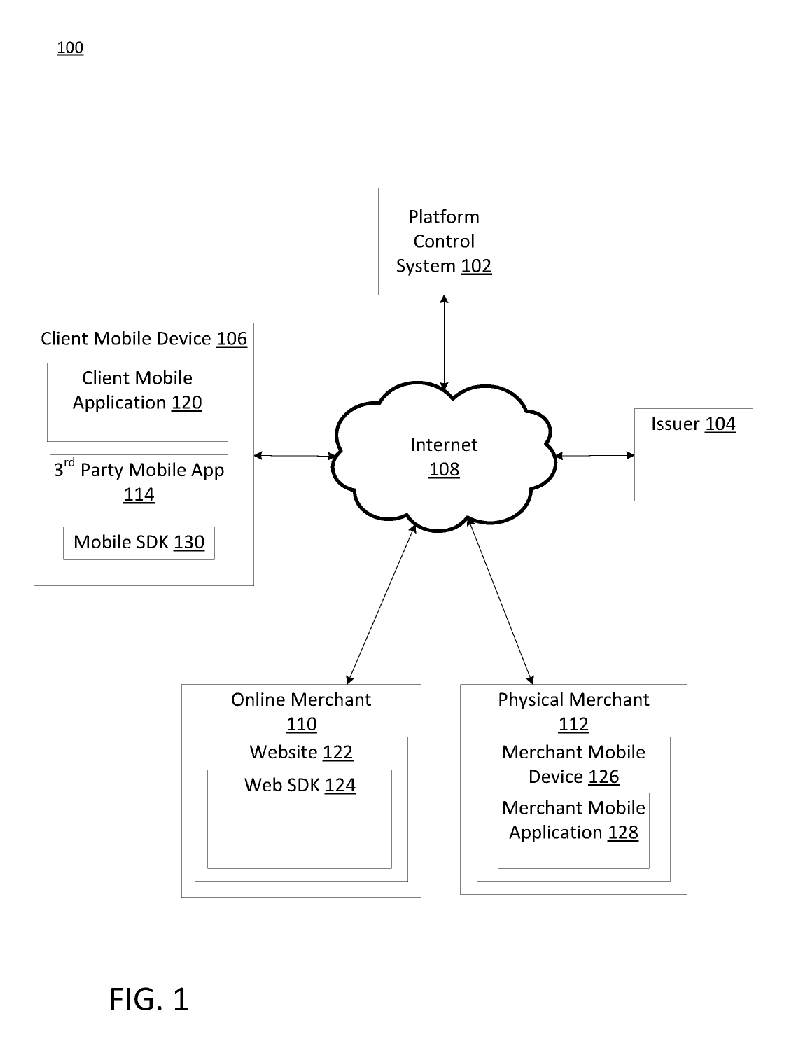

FIG. 1 illustrates a digital payments platform 100, according to one embodiment. The platform 100 includes a platform control system 102 (or simply “system”), an issuer 104, a client mobile device 106, an online merchant 110, a physical merchant 112, and a third-party mobile app 114. These components are connected via the Internet 108. In various embodiments, one or more components may not be used.

The platform control system (PCS) 102 facilitates interactions between the previously described parties for the purpose of completing payment transactions involving one or more of the parties within the platform 100. The PCS 102 is typically owned, developed, and administered by an enterprise.

The issuer 104 may be part of a bank or a financial institution system that issues a payment instrument to a payer. The payment instrument may be based on a specific card network system. Some of the well-known card network systems are card systems based on VISA®, MasterCard®, Discover® and American Express® card network systems.

When an issuer 104 issues a payment instrument to an accountholder, it retains a record of various information related to the payment instrument and the accountholder (or “user”). Some of the information stored by issuer 104 may include the name of the accountholder, the address of the accountholder, contact information for the accountholder, payment instrument identification number, expiration date of the payment instrument, and the amount of available funds on the payment instrument. The issuer 104 may also store one or more additional identification numbers specifically issued to the payment instrument. Some of the information stored by the issuer 104 may be physically printed on the payment instrument.

In typical embodiments, a magnetic strip data store may be affixed to the payment instrument. In some examples, other types of memory devices may be affixed to the payment instrument. In some examples, the payment instrument may be a virtual instrument, with corresponding issuer data and accountholder data stored in a data store corresponding to the virtual instrument. In some examples, one or more fields of data may be physically displayed or printed on the payment instrument and the merchant or the accountholder may have to enter the data manually. In yet another example, some of the fields of data may not be physically present on the payment instrument, but is instead known and retained by the accountholder and provided as required. As an example, the zip code of the payer may not be present on the payment instrument and the accountholder manually enters the data corresponding to the zip code, at the instrument reader system or computing device, at the point of sale of the goods and services.

The client mobile device 106 may be a mobile electronic device including hardware, software, or embedded logic components or a combination of two or more such components and capable of accessing the Internet. In an embodiment, the client mobile device 106 is a smartphone equipped with a SIM card. The client mobile device 106 includes a client mobile application (or CMA) 120. The CMA 120 allows a user to load funds as well as other payment instruments (e.g. debit/credit cards) for use in payment transactions on the platform 100. The CMA 120 further allows the user to approve and initiate payment transactions from within the application. The CMA 120, as will be described in detail later, is developed and/or maintained by the same enterprise which maintains the platform control system 102.

The client mobile device 106 may further include a third-party mobile application (TPMA) 114. The TPMA 114 may be a mobile application published by a popular e-commerce website (such as Amazon™), within which a user can browse and purchase products and services. The TPMA 114 includes a mobile software development kit (SDK) 130. The mobile SDK 130 is configured to allow a user or owner of the client mobile device 106 to initiate a payment transaction over the platform 100 from within the TPMA 114 itself.

The online merchant 110 sells products and/or services over the Internet. The online merchant 110 publishes or administers a website 122. This website 122 is accessible over the Internet 108 via a mobile or desktop Internet browser. Generally, the website 122 features products and/or services for sale by the merchant. The website 122 further includes a Web Software Development Kit (or “Web SDK”) 124. The Web SDK 124 is, in typical embodiments, a piece of software configured to allow visitors to the website 122 to enter credentials and/or payment instrument information in order to initiate a payment transaction using the platform 100.

The physical merchant 112 is a merchant existing in the physical space (such as a supermarket or clinic). Generally, the physical merchant 112 features a point-of-sale location (such as a checkout counter) at which store customers provide payment instrument information in order to conduct a payment transaction. Generally, in most contexts, customers make use of a physical payment instrument—such as a plastic debit card or credit card—in order to conduct the payment transaction. The physical merchant 112 features at a point-of-sale location a merchant mobile device 126. The merchant mobile device 126 is configured to run a merchant mobile application 128. The merchant mobile application 128, as will be described in detail later, may be configured to convey to a customer the details of a payment transaction as well as to receive payment instrument information.

### Functionality of a Client Mobile Application

The client mobile application (CMA) 120, described previously with reference to FIG. 1, may be developed and maintained by the same enterprise which manages the platform control system 102. The client mobile application 120 is a multi-function mobile application, and in most embodiments serves as the primary method of control for users of the platform 100. In some embodiments, the client mobile application 120 may be referred to as a “mobile wallet” or a “wallet app”. As described previously, the client mobile application 120 allows a user to load funds as well as link other payment instruments (e.g. debit/credit cards) for use in payment transactions on the platform 100. The client mobile application 120 further allows the user to initiate, monitor, and control payment transactions from within the application.

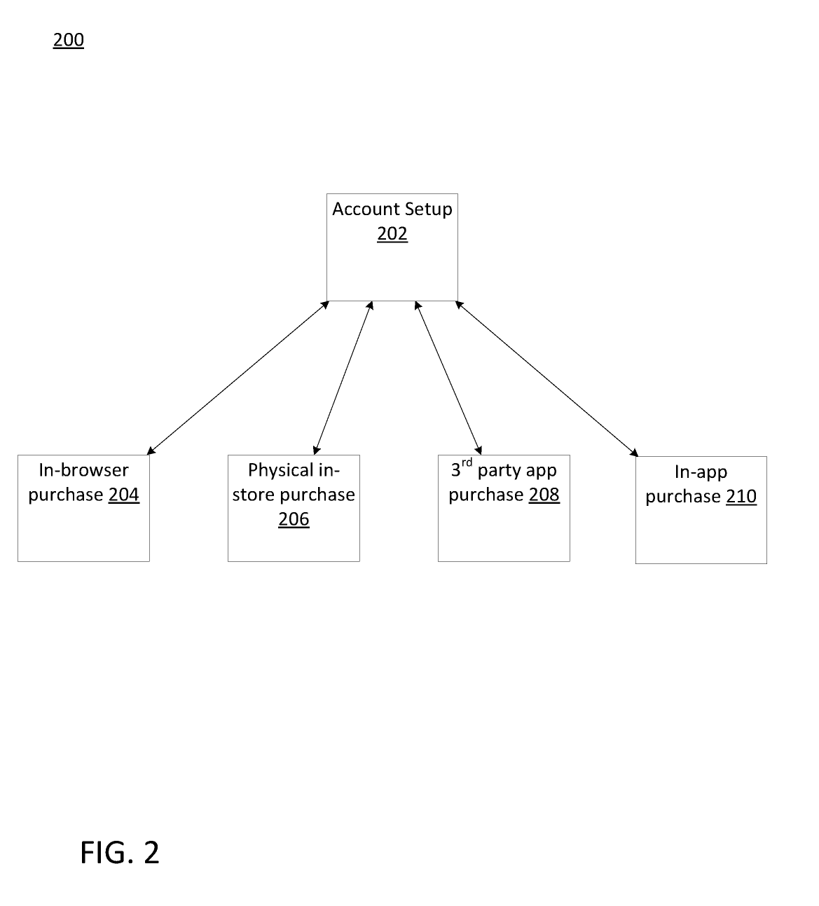

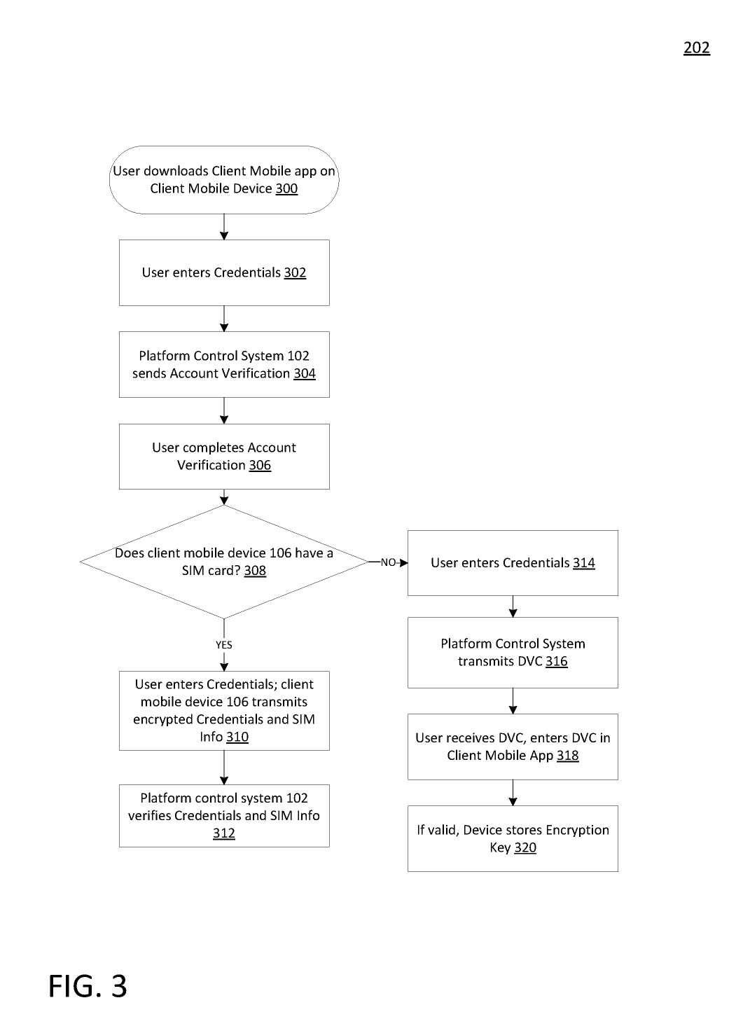

FIG. 2 is a diagram illustrating a client mobile application 120 of a digital payment platform, according to one embodiment. The environment graphically depicts the key functionality components of the client mobile application 120. The client mobile application 120 first includes functionality for account setup 202. Account setup 202 refers to registration by the user with the platform 100, as will be described in detail with reference to FIG. 3. Subsequent to successful account setup, users can use the client mobile application 120 to control, monitor, and approve digital payment transactions across a variety of channels within the platform 100.

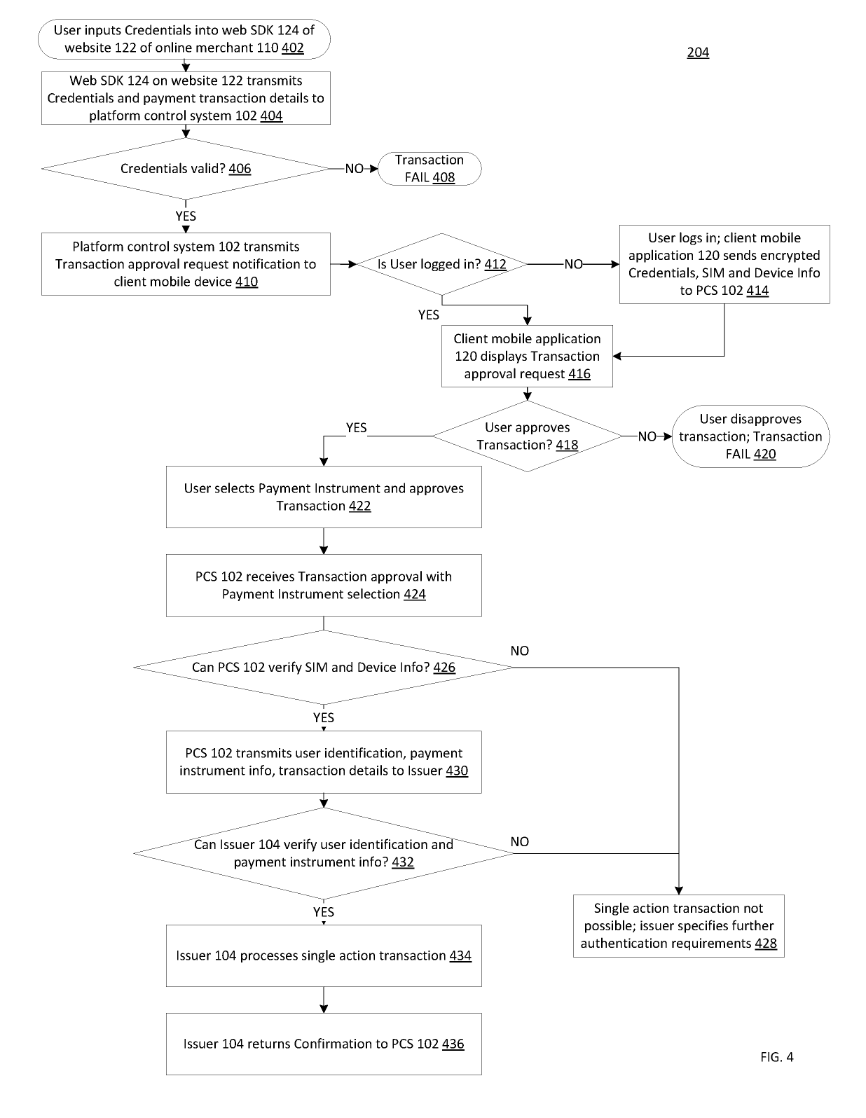

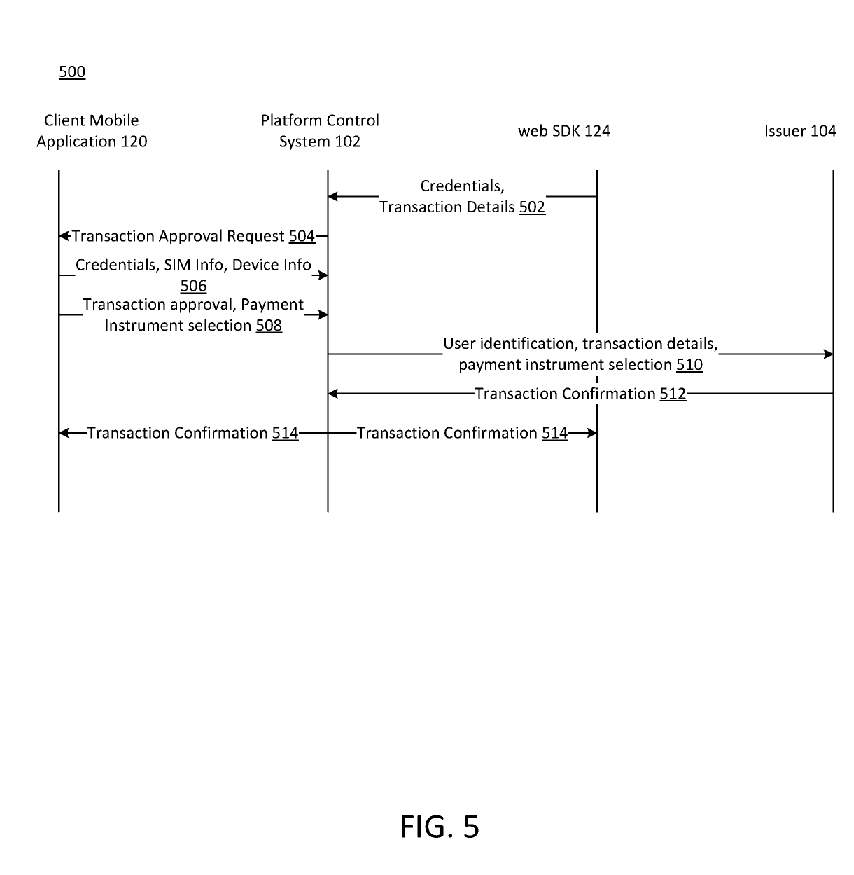

The first such channel involves in-browser purchases 204, in which the user purchases a product or service on a website of an online merchant 110, using an external mobile device or computer. As will be described in detail with reference to FIGS. 4-5, the user can initiate a transaction on a website 122 of a participating online merchant 110 and use the client mobile application 120 (executing on his/her client mobile device 106) to approve, modify, and monitor the transaction.

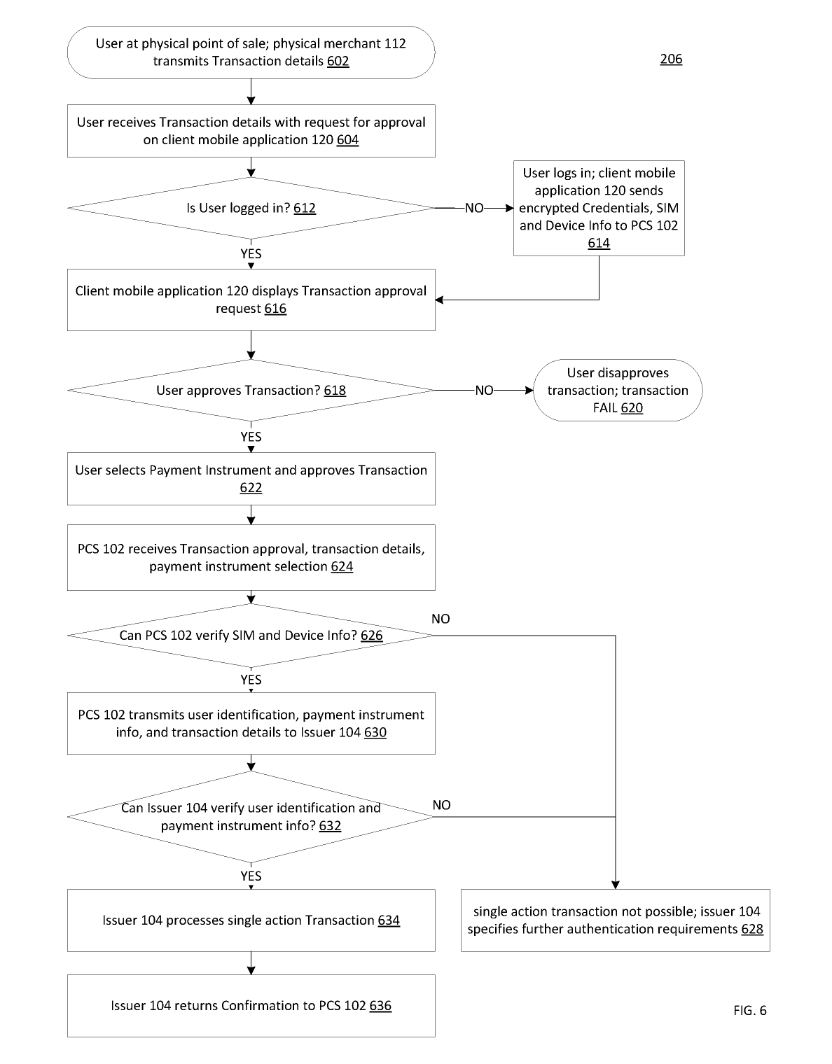

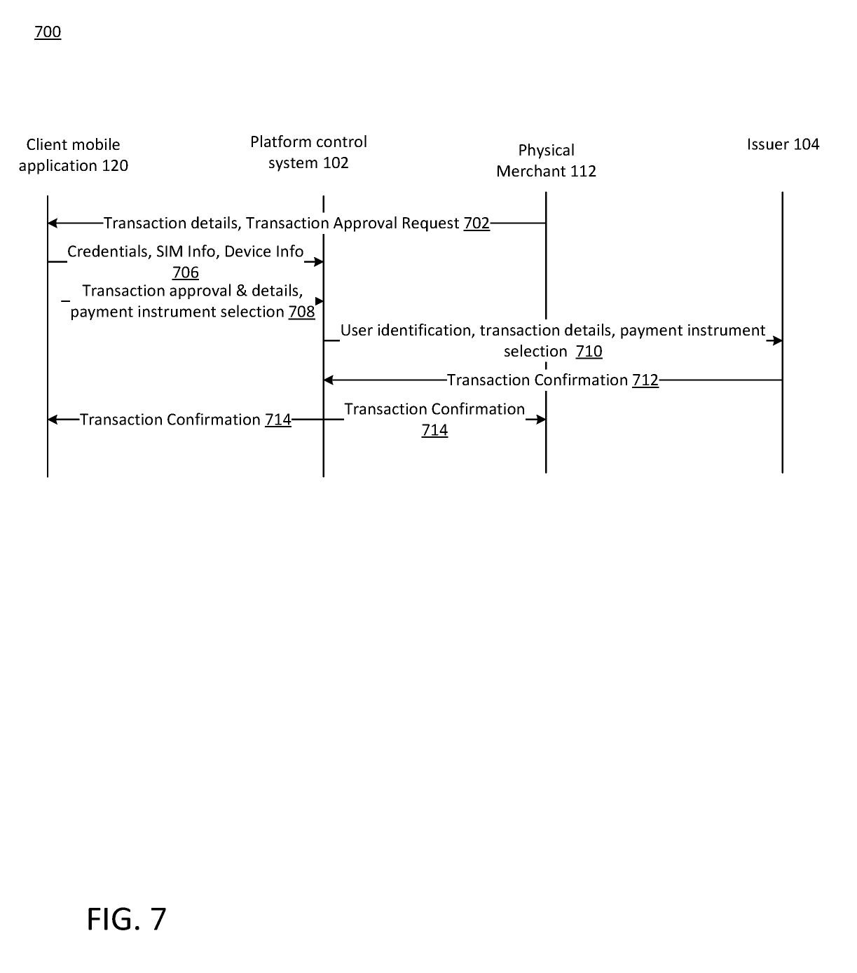

Another channel involves physical in-store purchases 206. As will be described in detail with reference to FIGS. 6-7, a user executes a digital transaction at a point-of-sale (POS) at a physical merchant 112, such as the checkout counter of a supermarket. The user can receive and view details of the transaction on the client mobile application 120 (executing on his/her client mobile device 106), and approve, modify, and monitor the transaction. As will be described later in detail, physical in-store purchases 206 may involve the use of a merchant mobile device 126, itself configured to execute a merchant mobile application 128. The merchant mobile application 128 may, in some embodiments, convey transaction or payment instrument information to the client mobile application 120 via a wireless communication technology such as NFC or Bluetooth®.

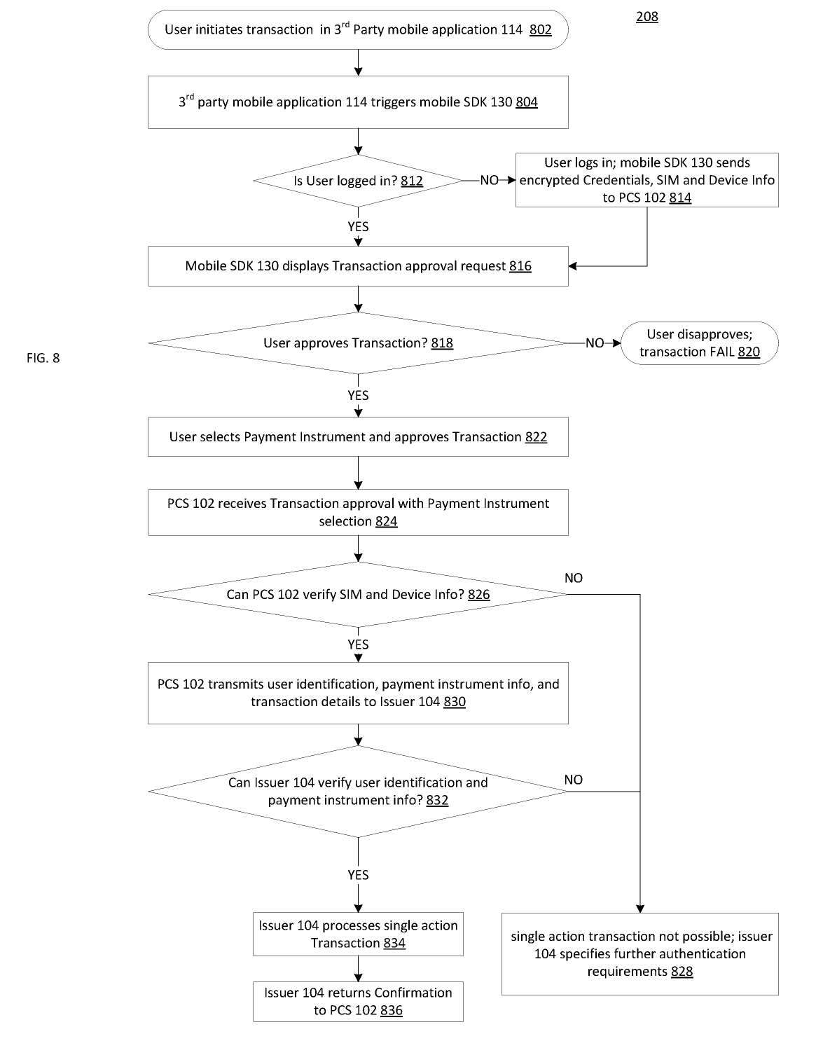

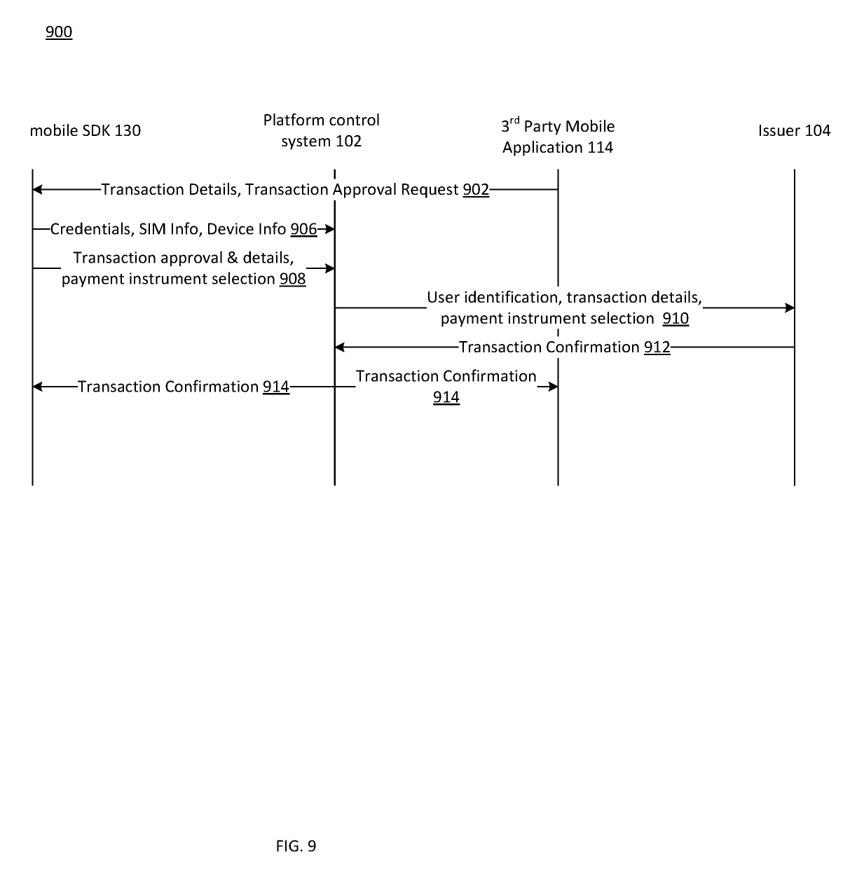

Still another channel involves third-party application purchases 208. As will be described in detail with reference to FIGS. 8-9, a user executes a digital transaction within a third-party mobile application 114 executing on the client's own mobile device 106. This third-party mobile application 114 could be a common shopping or e-commerce app which sells products or services over the Internet. In some embodiments, the third-party mobile application 114 integrates a mobile SDK 130 which allows the user to initiate a payment transaction from within the third-party mobile application 114 itself. The mobile SDK 130 is developed and/or maintained by the enterprise which administers the platform control system 102 as well as the client mobile application 120. Using the mobile SDK, 130, a user can approve, modify, or monitor a transaction.

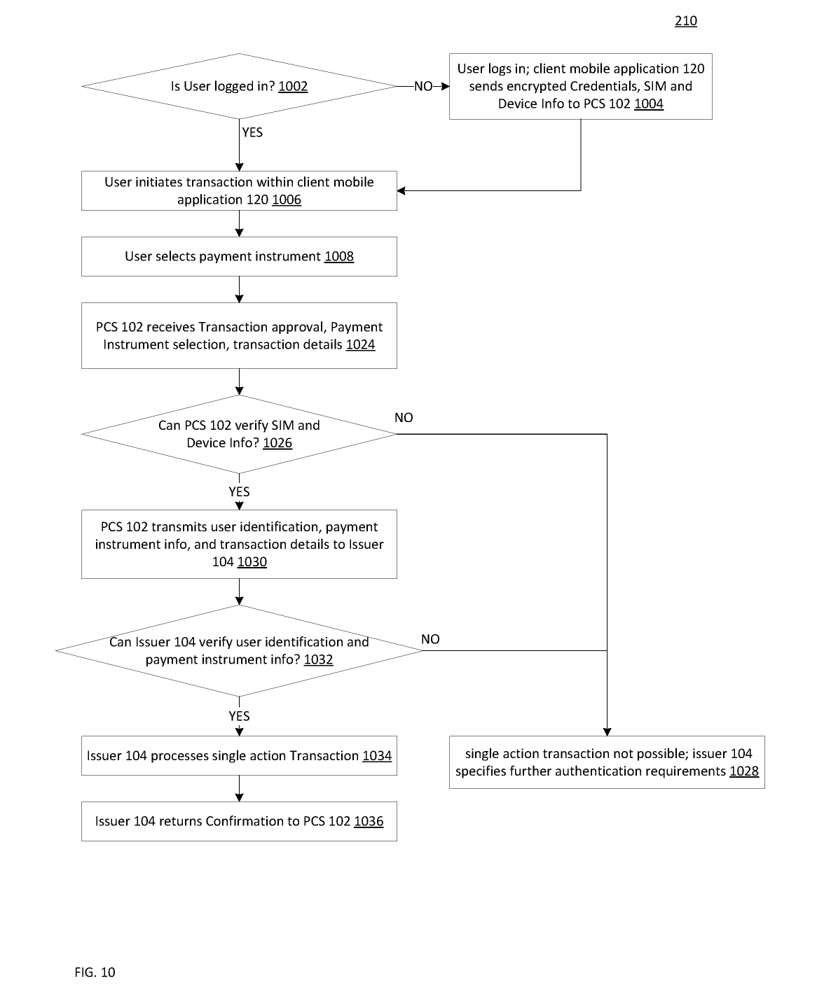

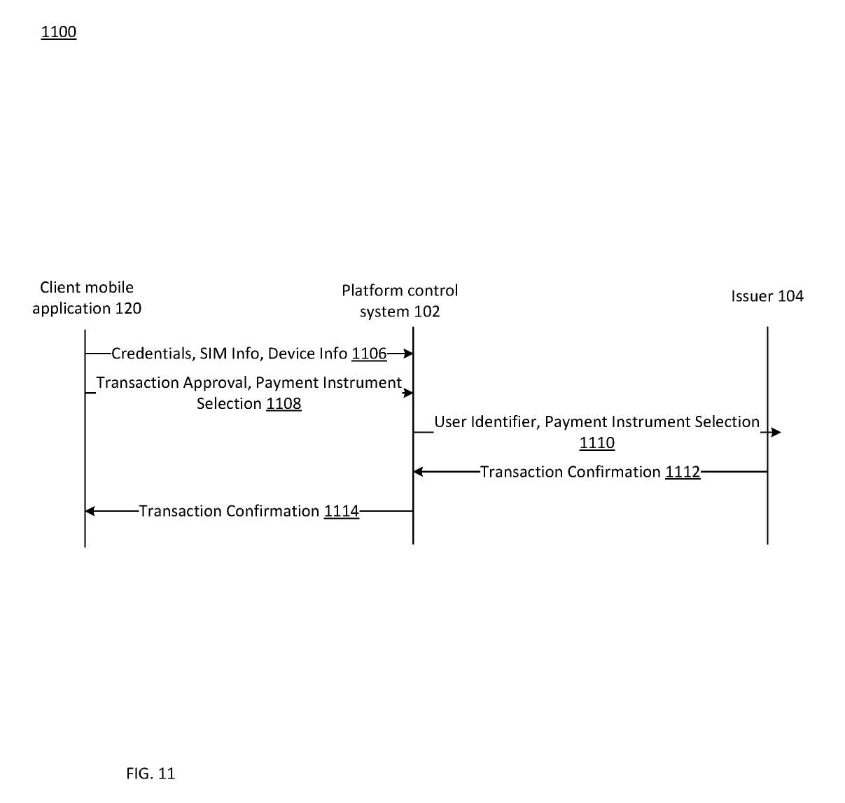

Still another channel involves in-app purchases 210. As will be described in detail with reference to FIGS. 10-11, a user can initiate a digital transaction from within the client mobile application 120. In some embodiments, the client mobile application 120 itself offers products/services for sale (for example through a digital catalog embedded into the application).

### User Registration in a Digital Payments Platform

In order to execute payment transactions within the platform 100, users may complete a registration process. The process includes recordation of information identifying the user as well as information identifying one or more of his internet-enabled devices. In an embodiment, the user initiates the registration process using the client mobile device 106.

FIG. 3 is a flowchart illustrating a process for registering a user with the digital payments platform, according to one embodiment. The user firsts downloads 300 the client mobile application 120 on their client mobile device 106. The client mobile application 120 prompts the user to enter 302 a series of credentials into the client mobile application 120. In one embodiment, these credentials include an email address controlled by the user, or a mobile number associated with the client mobile device 106. The user also selects a personal identification number (PIN). The user may also be prompted to provide a security question and accompanying answer. In further embodiments, the client mobile device 106 may include components for capturing biometric information associated with the user, such as a fingerprint or retina scan. The client mobile application 120 may prompt the user to enter this and other biometric information. These credentials are then transmitted to the platform control system 102, which transmits 304 account verification information to the user. In some embodiments, this account verification information may be sent via SMS to the mobile number entered by the user. In other embodiments, the account verification information may be emailed to the email address provided by the user. The user, upon receipt of the account verification information, completes 306 the account verification process. This is typically accomplished by entering the account verification information into the client mobile application 120. The account verification information is transmitted by the client mobile device 106 to the platform control system 102, which verifies that the account verification information it received matches the account verification information that it sent out.

In order to complete the registration process, the user may be prompted to log in to the client mobile application 120. At this time, the client mobile application 120 determines 308 if the client mobile device 106 has a SIM card. If it does, the user enters a set of his/her credentials (typically, mobile number or email, and PIN). The user may also enter one or more kinds of biometric information, such as a fingerprint or retina scan, if the client mobile device 106 includes components configured to capture this kind of data. The client mobile device 106 transmits these credentials 310 along with information describing the SIM card present on the client mobile device 106. In one embodiment, the SIM information includes an identification number (ID) of the SIM card. The SIM ID may be encrypted using an asymmetric encryption algorithm, such as RSA. The credentials may be encrypted using this same asymmetric encryption algorithm as well. It should be noted that other cryptographic schemes may be utilized, such as symmetric encryption (AES) or message digest algorithms like SHA-256 or some other forms of cryptographic methods has and when they may become available.

The platform control system 102 receives and verifies 312 the encrypted credentials and SIM information. In one embodiment, the platform control system 102 decrypts the SIM information and uses it to retrieve the associated mobile number from the appropriate cellular carrier. The platform control system 102 verifies that this mobile number matches the mobile number registered to the account (if a mobile number was used to register the account) and stores a record linking the mobile number to the decrypted SIM information.

If the client mobile device 106 does not have a SIM card, the user enters 314 his/her credentials as previously described, which are then encrypted and transmitted by the client mobile device 106 to the platform control system 102. Upon receipt of these credentials, the platform control system 102 transmits 316 a device verification code (or DVC) via SMS or email. The user receives this DVC and enters it 318 into the client mobile application 120. The client mobile device 106 transmits the DVC to the platform control system 102, which verifies that it is correct. If it is, the platform control system 102 returns a device-specific public encryption key to the client mobile device 106. The public encryption key may itself be encrypted using a symmetric encryption algorithm. The client mobile device 106 stores 320 the public encryption key in a secure area of the client mobile application 120.

In an alternate embodiment, the platform control system 102 may transmit a DVC even if the client mobile device 106 does include a SIM card. This may be performed in order to further verify that the mobile phone number and client mobile device 106 are uniquely associated with each other.

Initiating Transactions with a Single Action

Users who successfully register on the platform 100, as described previously, are able to approve and execute transactions with a variety of parties by performing a single action on their client mobile device 106. Single action transactions simplify digital transactions for a user of the platform 100 by reducing the effort required for the user to execute the transaction. Traditionally, users who wish to execute a payment transaction must provide a physical payment instrument (if executing a transaction at a physical point of sale) or manually enter payment instrument information (if executing a transaction in a digital context, such as a checkout page of an e-commerce website). By contrast, within the platform 100, users execute a transaction on their client mobile device 106 by simply clicking a single button within the client mobile application 120, or within the mobile SDK 130 of a third-party mobile app 114 running on the client mobile device 106. This single action transaction may also be referred to as a “one-step payment”.

Single Action Transactions with Online Merchants of the Digital Platform

As described previously, users of the platform 100 can execute payment transactions with an online merchant 110 of the platform 100. In typical embodiments, the online merchant 110 maintains a website 122, which includes a web SDK 124 (as described previously). In some embodiments, the web SDK 124 is developed and maintained by the same enterprise which manages/administers the platform control system 102 and client mobile application 120. Further, the web SDK 124 may be implemented as an applet or plugin featuring an interactive graphical user-interface element. Online merchants 110 who include the web SDK 124 into their website(s) 122 may be referred to as “participating merchants” or “member merchants”.

The Web SDK 124 is configured to receive a user's credentials (phone number or email and PIN) for the purposes of executing a payment transaction. The user's credentials are entered by a registered user of the platform 100 at the time he/she wishes to execute a payment transaction. The Web SDK 124 is further configured to transmit the credentials to the platform control system 102.

FIG. 4 is a flowchart illustrating the process of completing a single-action payment transaction via a website of an online merchant, according to one embodiment. A user inputs 402 credentials into the web SDK 124 of the website 122 of the online merchant 110. These credentials, as described previously with reference to FIG. 3, typically include an email address or mobile number and PIN which uniquely identify the user's account. The web SDK 124 transmits 404 the credentials to the platform control system 102. The web SDK 124 also transmits details describing the payment transaction. In some embodiments, these payment transaction details may include a merchant ID, a merchant name, a merchant type, a request date-time, a merchant location, and a payment amount.

The platform control system 102 receives the credentials and payment transaction details from the web SDK 124. The platform control system 102 determines 406 if the credentials are valid—in other words, if the email address or mobile number and PIN are correct and match a valid user account. If the credentials are not valid, the payment transaction reaches 408 a FAIL state. If the credentials are valid, the platform control system (PCS) 102 transmits 410 a transaction approval request to the client mobile device 106. In some embodiments, this transaction approval request contains information describing the online merchant 110 as well as the transaction itself. The transaction approval request is first displayed as a notification on the client mobile device 106; clicking on the notification causes the client mobile application 120 to be opened. The client mobile application 120 determines 412 if the user is logged in (has an active session). If the user is not logged in, the user logs in, and the client mobile application 120 transmits 414 the user credentials, as well as SIM information and device information to the platform control system 102. As described previously, the SIM information may include an identification number (ID) of the SIM card. The SIM ID may be encrypted using an asymmetric encryption algorithm, such as RSA. The credentials may also be encrypted using this same asymmetric encryption algorithm. Device information may include a unique identifier for the client mobile device 106, such as its IMEI number, serial number, or UDID.

If the user is logged in, then the client mobile application 120 displays 416 the transaction approval request. In some embodiments, the user is presented with a single button which, if clicked, will signal approval or disapproval of the payment transaction. At this time, the user decides 418 to approve or disapprove the transaction. If the user disapproves 420 the transaction, the transaction reaches a terminal FAIL state. If the user approves 422 the transaction, the user clicks the button, performing the “single action” as previously described. In typical embodiments, at the time of approval, the user also selects one of multiple payment instrument choices with which to execute the transaction. In typical embodiments, a default payment instrument is selected, so that the user does not need to manually select a payment instrument. The user's approval, as well as his/her selection of a payment instrument, is transmitted by the client mobile application 120 to the platform control system 102. The platform control system 102 receives 424 the transaction approval and payment instrument selection. The platform control system 102 then determines 426 if it can verify SIM information and/or device information associated with the user. In some embodiments, the platform control system 102 retains SIM information and/or device information that are transmitted by the client mobile application 120 at the time of session activation at the client mobile device 106. It should be noted that transmission of this information can occur at some time prior to initiation of a payment transaction by a user, or it could occur when a user logs in to the client mobile application 120 subsequent to receiving a transaction approval request on his/her client mobile device 106. Verification of the SIM information and/or device information may involve, in some embodiments, decryption of encrypted data using a private decryption key. In other embodiments, the platform control system 102 performs the same encryption steps performed at the client mobile device 106 and compares its result against the SIM information and/or device information received from the client mobile device 106.

If the platform control system 102 cannot verify the SIM information and/or device information, then a single action transaction is not possible. The platform control system 102 notifies the appropriate issuer 104. The issuer 104 then specifies 428 further authentication requirements in order to process the payment transaction. In some embodiments, further authentication requirements include prompting the user to enter a PIN specific to the selected payment instrument and/or a card verification code (CVC) into the client mobile application 120 in order to proceed with the payment transaction.

If instead the platform control system 102 is able to verify the SIM information and/or device information, the platform control system 102 then transmits 430 an identification of the user, the user's payment instrument selection, and select transaction details to the appropriate issuer 104. The issuer 104 verifies 432 if the user identifier and payment instrument selection match its own records and are associated with a valid and/or active payment instrument. In some embodiments, the issuer 104 may also verify, if necessary, that the selected payment instrument contains sufficient funds to execute the transaction. If any of these are not successful, then a single action transaction is not possible; the issuer 104 specifies 428 further authentication requirements as previously described, or terminates the transaction altogether (in the case of insufficient funds).

If the issuer 104 is able to verify the user identifier and payment instrument selection, the issuer 104 proceeds to process 434 the single action transaction. The issuer 104 returns 436 a confirmation message to the platform control system 102. The platform control system 102 may then notify both the online merchant 110 and the user of successful execution of the payment transaction.

In alternate embodiments, the platform control system 102 and/or issuer 104 may prescribe additional authentication requirements based on a real-time evaluation of one or more risk factors. For example, if the value of the intended transaction exceeds a threshold amount, the user may be asked to enter a PIN associated with the selected payment instrument, even if the platform control system 102 was able to verify the SIM information and device information associated with the client mobile device 106. Or, if the location of the client mobile device 106 is determined to be in a geographical area associated with increased fraudulent activity, the platform control system 102 and/or issuer 104 may again require the user to input his/her PIN. Other examples which may involve enhanced authentication requirements include transactions with high risk merchants or merchant classes, or transactions conducted with unusual frequency or at unusual times.

FIG. 5 is a diagram illustrating the process of completing a single-action payment transaction via a website of an online merchant, according to one embodiment. The object interaction diagram 500 describes the interactions that occur between the client mobile application 120, the platform control system 102, the web SDK 124, and the issuer 104 in the process of completing a single-action payment transaction via a website of an online merchant. First, subsequent to provision of credentials by a user into the web SDK 124 installed on a website 122 of the online merchant 110, the web SDK 124 transmits 502 the user credentials as well as details describing the transaction to the platform control system 102. Next, the platform control system 102 transmits 504 a transaction approval request to the client mobile application 120 executing on the client mobile device 106. If the user is not logged into the client mobile application 120, he/she logs in, causing the client mobile application 120 to transmit 506 the user credentials, along with information about the SIM card and the device itself, to the platform control system 102. As described earlier, this information may be encrypted or otherwise obscured using one or more cryptographic techniques. Next, if the user approves the transaction on the client mobile device 106, the client mobile application 120 returns 508 approval of the transaction, along with a selection of a payment instrument with which to execute the transaction. The platform control system 102 then transmits 510 a user identification along with the payment instrument information and select transaction details to the appropriate issuer 104. If the issuer 104 is able to verify the user identification as well as the payment instrument information, the issuer 104 completes the single action transaction and returns 512 a transaction confirmation to the platform control system 102. The platform control system 102 may then transmit 514 a confirmation of the transaction to the web SDK 124 and to the client mobile application 120.

Single Action Transactions with Physical Merchants of the Digital Platform

As described previously, users of the platform 100 can execute payment transactions with a physical merchant 112 of the platform 100. In one embodiment, the physical merchant 112 operates a merchant mobile device 126, configured to execute a merchant mobile application 128. The merchant mobile device 126 and the merchant mobile application 128 together perform the function of a traditional point-of-sale (POS) device. The merchant mobile device 126 may further be equipped with technologies such as near-field communication (NFC) or Bluetooth, which allow the merchant mobile device 126 to communicate wirelessly with a client mobile device 106 at close ranges (typically less than 1 meter). The merchant mobile device 126 may be directed by the merchant mobile application 128 to transmit transaction details and/or payment instrument information between the user and the physical merchant 112.

FIG. 6 is a flowchart illustrating the process of completing a single action payment transaction at a physical point of sale, according to one embodiment. A user arrives at a physical point of sale such as the checkout counter of a supermarket. The physical merchant 112, via his/her merchant mobile application 128, transmits 602 transaction details to the client mobile device 106 of the user. As described previously, this may be accomplished via one of multiple communication technologies (NFC, Bluetooth, etc.). In alternate embodiments, the user may actively acquire the transaction details by scanning a QR code that is displayed on a screen of the merchant mobile device 126. Next, the user receives 604 the transaction details. In some embodiments, receipt of the transaction details may trigger a transaction approval request within the client mobile application 120 of the client mobile device 106.

Before displaying the transaction approval request, the client mobile application 120 first determines 612 if the user is logged in (has an active session). If the user is not logged in, the user logs in, and the client mobile application 120 transmits 614 the user credentials, as well as SIM information and device information to the platform control system 102. As described previously, the SIM information may include an identification number (ID) of the SIM card. The SIM ID may be encrypted using cryptographic methods, such as AES, RSA, SHA-256 or combination of more than one cryptographic methods may also be used. Device information may include a unique identifier for the client mobile device 106, such as its IMEI number.

If the user is logged in, then the client mobile application 120 displays 616 the transaction approval request. In some embodiments, the user is presented with a single button which, if clicked, will signal approval or disapproval of the payment transaction. The user then decides 618 to approve or disapprove the transaction. If the user disapproves 620 the request, the transaction reaches a terminal FAIL state. If the user approves 622 the transaction, the user clicks the button. In typical embodiments, at the time of approval, the user also selects one of multiple payment instrument choices with which to execute the transaction. The user's approval, as well as his/her selection of a payment instrument, is transmitted by the client mobile application 120 to the platform control system 102. The platform control system 102 receives 624 the transaction approval and payment instrument selection. The platform control system 102 then determines 626 if it can verify SIM information and/or device information associated with the user. In some embodiments, the platform control system 102 retains SIM information and/or device information that are transmitted by the client mobile application 120 at the time of session activation from the client mobile device 106. It should be noted that transmission of this information can occur at some time prior to initiation of a payment transaction by a user, or it could occur when a user logs in to the client mobile application 120 subsequent to receiving a transaction approval request notification on his/her client mobile device 106. Verification of the SIM information and/or device information may involve, in some embodiments, decryption of encrypted data using a private decryption key. In other embodiments, the platform control system 102 has knowledge of the encryption process performed by the client mobile application 120, and it simply performs the same encryption steps and compares its result against the SIM information and/or device information received from the client mobile device 106.

If the platform control system 102 cannot verify the SIM information and/or device information, then a single action transaction is not possible. The platform control system 102 notifies the appropriate issuer 104. The issuer 104 then specifies 628 further authentication requirements in order to process the payment transaction. In some embodiments, further authentication requirements include prompting the user to enter a PIN specific to the selected payment instrument and/or a card verification code (CVC) into the client mobile application 120 in order to proceed with the payment transaction.

If instead the platform control system 102 is able to verify the SIM information and/or device information, the platform control system 102 then transmits 630 an identification of the user, the user's payment instrument selection, and select transaction details to the appropriate issuer 104. The issuer 104 verifies 632 if the user identifier and payment instrument selection match its own records and are associated with a valid and/or active payment instrument. In some embodiments, the issuer 104 may also verify, if necessary, that the selected payment instrument contains sufficient funds to execute the transaction. If any of these are not successful, then a single action transaction is not possible; the issuer 104 specifies 628 further authentication requirements as previously described, or terminates the transaction altogether (in the case of insufficient funds).

If the issuer 104 is able to verify the user identifier and payment instrument selection, the issuer 104 proceeds to process 634 the single action transaction. The issuer 104 returns 636 a confirmation message to the platform control system 102. The platform control system 102 may then notify the physical merchant 112 and the user of successful completion of the transaction.

FIG. 7 is a diagram illustrating the process of completing a single action payment transaction at a physical point of sale, according to one embodiment. The object interaction diagram 700 describes the interactions that occur between the client mobile application 120, the platform control system 102, the physical merchant 112, and the issuer 104 in the process of completing a single-action payment transaction at a physical point of sale. First, at the physical point of sale (e.g. checkout counter of supermarket), the user performs an NFC or Bluetooth “tap” or scans a QR code displayed by the physical merchant 112. This causes the physical merchant 112 to transmit 702 transaction details along with a request for approval to the client mobile application 120. Before the user can approve the transaction on his/her device 106, if the user is not logged into the client mobile application 120, he/she logs in, causing the client mobile application 120 to transmit 706 the user credentials, along with information about the SIM card and the device itself, to the platform control system 102. As described earlier, this information may be encrypted or otherwise obscured using one or more cryptographic techniques. Next, if the user approves the transaction on the client mobile device 106, the client mobile application 120 returns 708 approval of the transaction, along with a selection of a payment instrument with which to execute the transaction. The platform control system 102 then transmits 710 a user identification along with the payment instrument information and select transaction details to the appropriate issuer 104. If the issuer 104 is able to verify the user identification as well as the payment instrument information (including availability of funds), the issuer 104 completes the single action transaction and returns 712 a transaction confirmation to the platform control system 102. The platform control system 102 may then transmit 714 a confirmation of the transaction to both the physical merchant 112 and the client mobile application 120.

Single Action Transactions with Third-Party Applications of the Digital Platform

As described previously, users of the digital payment platform 100 can execute payment transactions within a third-party mobile application (TPMA) 114 of the platform 100. In typical embodiments, the mobile SDK 130 is owned and maintained by the administrators of the platform control system 102 and is made available for integration with the third-party mobile application 114. Third-party mobile applications 114 that integrate the mobile SDK 130 may be referred to as “members” or “participating apps” of the platform 100. Typically, these apps are e-commerce or shopping apps that offer products or services for sale within the mobile application itself. A user browsing through a TPMA 114 on his/her client mobile device 106 can complete a purchase from directly within the application by using the mobile SDK 130.

FIG. 8 is a flowchart illustrating the process of completing a single action payment transaction within a third-party mobile application, according to one embodiment. A user, while browsing in a third-party mobile application 114 on his/her client mobile device 106, initiates 802 a transaction, typically by pressing a “purchase” button. This causes the third-party mobile application 114 to trigger 804 the mobile SDK 130. Typically, the third-party mobile application 114 also transmits a transaction approval request, along with select transaction details (such as the cost of the item to be purchased) to the mobile SDK 130. Before displaying the transaction approval request and associated transaction details, the mobile SDK 130 first determines 812 if the user is logged in (in other words, if he/she has an active session). If the user is not logged in, the user logs in, and the mobile SDK 130 transmits 814 the user credentials, as well as SIM information and device information to the platform control system 102. As described previously, the SIM information may include an identification number (ID) of the SIM card. The SIM ID may be encrypted using an asymmetric encryption algorithm, such as RSA. The credentials may be encrypted using this same asymmetric encryption algorithm as well. Device information may include a unique identifier for the client mobile device 106, such as its IMEI number.

If the user is logged in, then the mobile SDK 130 displays 816 the transaction approval request and associated transaction details. In some embodiments, the user is presented with a single button which, if clicked, will signal approval or disapproval of the payment transaction. The user then decides 818 to approve or disapprove the transaction. If the user disapproves 820 the request, the transaction reaches a terminal FAIL state. If the user approves 822 the transaction, the user clicks the button. In typical embodiments, at the time of approval, the user also selects one of multiple payment instrument choices with which to execute the transaction. The user's approval, as well as his/her selection of a payment instrument, is transmitted by the mobile SDK 130 to the platform control system 102. The platform control system 102 receives 824 the transaction approval and payment instrument selection. The platform control system 102 then determines 826 if it can verify SIM information and/or device information associated with the user. In some embodiments, the platform control system 102 retains SIM information and/or device information that was transmitted by the client mobile application 120 at the time of session activation on the client mobile device 106. It should be noted that transmission of this information can occur at some time prior to initiation of a payment transaction by a user, or it could occur when a user logs in to the mobile SDK 130 from within the third-party mobile application 114. Verification of the SIM information and/or device information may involve, in some embodiments, decryption of encrypted data using a private decryption key. In other embodiments, the platform control system 102 has knowledge of the encryption process performed by the mobile SDK 130, and it simply performs the same encryption steps and compares its result against the SIM information and/or device information received from the client mobile device 106.

If the platform control system 102 cannot verify the SIM information and/or device information, then a single action transaction is not possible. The platform control system 102 notifies the appropriate issuer 104. The issuer 104 then specifies 828 further authentication requirements in order to process the payment transaction. In some embodiments, further authentication requirements include prompting the user to enter a PIN specific to the selected payment instrument and/or a card verification code (CVC) into the client mobile application 120 in order to proceed with the payment transaction.

If instead the platform control system 102 is able to verify the SIM information and/or device information, the platform control system 102 then transmits 830 an identification of the user, the user's payment instrument selection, and select transaction details to the appropriate issuer 104. The issuer 104 verifies 832 if the user identifier and payment instrument selection match its own records and are associated with a valid and/or active payment instrument. In some embodiments, the issuer 104 may also verify, if necessary, that the selected payment instrument contains sufficient funds to execute the transaction. If any of these are not successful, then a single action transaction is not possible; the issuer 104 specifies 828 further authentication requirements as previously described, or terminates the transaction altogether (in the case of insufficient funds).

If the issuer 104 is able to verify the user identifier and payment instrument selection, the issuer 104 proceeds to process 834 the single action transaction. The issuer 104 returns 836 a confirmation to the platform control system 102. The platform control system 102 may then notify the physical merchant 112 and the user of successful completion of the transaction.

FIG. 9 is a diagram illustrating the process of completing a single action payment transaction within a third-party mobile application, according to one embodiment. The object interaction diagram 900 describes the interactions that occur between the mobile SDK 130, the platform control system 102, the third-party mobile application 114, and the issuer 104 in the process of completing a single-action payment transaction from within the third-party mobile application 114. A user browsing within a third-party mobile application 114 on his/her client mobile device 106 decides to initiate a transaction. The third-party mobile application 114 transmits 902 a transaction approval request along with associated transaction details to the mobile SDK 130 (this may be referred to as “triggering” the mobile SDK 130). Before the user can approve the transaction, he/she must have an active session. If the mobile SDK 130 determines that the user does not currently have an active session, the user is prompted to log in. This causes the mobile SDK 130 to transmit 906 the user credentials, along with information about the SIM card and the device itself, to the platform control system 102. In some embodiments, the mobile SDK 130 may pass the user credentials to the client mobile application 120 executing on the same client mobile device 106, and request that the credentials, SIM information, and device information be shared with the platform control system 102. As described earlier, this information may be encrypted or otherwise obscured using one or more cryptographic techniques.

Next, if the user approves the transaction on the mobile SDK 130, the mobile SDK 130 (or the client application 120) returns 908 approval of the transaction, along with select transaction details (the amount to be paid and/or the merchant to be paid) as well as a selection of the payment instrument with which to execute the transaction. The platform control system 102 then transmits 910 an user identification along with the payment instrument information and select transaction details (e.g. amount and recipient) to the appropriate issuer 104. If the issuer 104 is able to verify the user identification as well as the payment instrument information (including availability of funds), the issuer 104 completes the single action transaction and returns 912 a transaction confirmation to the platform control system 102. The platform control system 102 may then transmit 914 a confirmation of the transaction to the mobile SDK 130 and/or the third-party mobile application 114.

Single Action Transactions within the Client Mobile Application of the Digital Platform

As described previously, users of the digital payment platform 100 can execute payment transactions within the client mobile application 120 executing on their client mobile device 106. In previously described embodiments, users use the client mobile application 120 to monitor and approve transactions initiated elsewhere, such as on a website of an online merchant 110, a point-of-sale at a physical merchant 112, or in a third-party mobile application 114. However, the client mobile application 120, which is developed and maintained by the administrators of the platform control system 102, can itself be configured to offer products or services for purchase. In one embodiment, the client mobile application 120 may feature a catalog, which the user can browse through. If the user wishes to purchase an item, he/she can initiate, approve, and execute the transaction, all within the client mobile application 120.

FIG. 10 is a flowchart illustrating the process of completing a single action payment transaction within a client mobile application, according to one embodiment. As described previously, the user must be logged in in order to access the client mobile application 120. The client mobile application 120 first determines 1002 if the user is logged in (i.e. if the user has an active session). If the user is not logged in, the user enters his/her credentials (email address or phone number and PIN); the client mobile application 120 transmits 1004 the user credentials, as well as SIM information and device information to the platform control system 102. As described previously, the SIM information may include an identification number (ID) of the SIM card. The SIM ID may be encrypted using an asymmetric encryption algorithm, such as RSA. The credentials may be encrypted using this same asymmetric encryption algorithm as well. Device information may include a unique identifier for the client mobile device 106, such as its IMEI number.

If the user is logged in, then the user is able to browse any products or services, which are available for sale within the client mobile application 120. The user decides to make a purchase and initiates 1006 a transaction within the client mobile application 120. In typical embodiments, at the time of initiation of the transaction, the user also selects 1008 one of multiple payment instrument choices with which to execute the transaction. The user's approval, select details of the transaction (e.g. amount to be paid), and his/her selection of a payment instrument, are all transmitted by the client mobile application 120 to the platform control system 102. The platform control system 102 receives 1024 the transaction approval and payment instrument selection. The platform control system 102 then determines 1026 if it can verify SIM information and/or device information associated with the user. In some embodiments, the platform control system 102 retains SIM information and/or device information that are transmitted by the client mobile application 120 at the time of session activation from the client mobile device 106. It should be noted that transmission of this information can occur at some time prior to initiation of a payment transaction by a user. Verification of the SIM information and/or device information may involve, in some embodiments, decryption of encrypted data using a private decryption key. In other embodiments, the platform control system 102 has knowledge of the encryption process performed by the client mobile application 120, and it simply performs the same encryption steps and compares its result against the SIM information and/or device information received from the client mobile device 106.

If the platform control system 102 cannot verify the SIM information and/or device information, then a single action transaction is not possible. The platform control system 102 notifies the appropriate issuer 104. The issuer 104 then specifies 1028 further authentication requirements in order to process the payment transaction. In some embodiments, further authentication requirements include prompting the user to enter a PIN specific to the selected payment instrument and/or a card verification code (CVC) into the client mobile application 120 in order to proceed with the payment transaction.

If instead the platform control system 102 is able to verify the SIM information and/or device information, the platform control system 102 then transmits 1030 an identification of the user, the user's payment instrument selection, and select transaction details to the appropriate issuer 104. The issuer 104 verifies 1032 if the user identifier and payment instrument selection match its own records and are associated with a valid and/or active payment instrument. In some embodiments, the issuer 104 may also verify, if necessary, that the selected payment instrument contains sufficient funds to execute the transaction. If any of these are not successful, then a single action transaction is not possible; the issuer 104 specifies 628 further authentication requirements as previously described, or terminates the transaction altogether (in the case of insufficient funds).

If the issuer 104 is able to verify the user identifier and payment instrument selection, the issuer 104 proceeds to process 1034 the single action transaction. The issuer 104 returns 1036 a confirmation message to the platform control system 102. The platform control system 102 may then return a confirmation to the client mobile application 120 indicating successful completion of the transaction.

FIG. 11 is a diagram illustrating the process of completing a single action payment transaction within a client mobile application, according to one embodiment. The object interaction diagram 1100 describes the interactions that occur between the client mobile application 120, the platform control system 102, and the issuer 104 in the process of completing a single-action payment transaction from within the client mobile application 120. First, in order to gain access to the client mobile application 120, the user logs in with his/her credentials (as described previously). The client mobile application 120 transmits 1106 the user credentials, along with information about the SIM card and the device itself, to the platform control system 102. As described earlier, this information may be encrypted or otherwise obscured using one or more cryptographic techniques. Next, the client mobile application 120 transmits 1108 approval of the transaction, along with a selection of a payment instrument with which to execute the transaction. The platform control system 102 then transmits 1110 an user identification along with the payment instrument information and select transaction details to the appropriate issuer 104. If the issuer 104 is able to verify the user identification as well as the payment instrument information (including availability of funds), the issuer 104 completes the single action transaction and returns 712 a transaction confirmation to the platform control system 102. The platform control system 102 may then transmit 714 a confirmation of the transaction to the client mobile application 120.

It should be noted that in some embodiments, the enterprise, which owns and maintains the client mobile application 120 may itself act as a merchant in some of the transactions which are performed at the client mobile application 120.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method for authorizing payment comprising:
receiving a first user credential;
receiving a first mobile number associated with a first user mobile device;
receiving at least one of a first SIM information associated with the first user mobile device or a first device verification code (DVC) associated with the first user mobile device;
receiving transaction details associated with a transaction;
receiving a first payment instrument identifier from a group of two or more payment instruments identifiers;
authorizing the first user by verifying that at least one of the first SIM information or the first DVC is associated with the first user credential;
transmitting information about the authorized first user, the first payment instrument identifier and the transaction details to an issuer associated with the first payment instrument identifier;
receiving an authorization of the transaction from the issuer.

2. The method of claim 1, further comprising transmitting the authorization of the transaction to the first user mobile device.

3. The method of claim 1, wherein authorizing the first user includes:
receiving biometric information; and
verifying that the biometric information is associated with the first user.

4. The method of claim 1, further comprising registering the first user including:
receiving first user credential information from the first user mobile device associated with a first mobile number;
transmitting an account verification request;
receiving an account verification response in response to the account verification request;
receiving the first SIM information; and
associating the first SIM information, the first mobile number and the first user credential information.

5. The method of claim 4, wherein first user credential information at least two of a first user email address, a first user personal identification number, a first user biometric information.

6. The method of claim 5, wherein the first user biometric information includes at least one of fingerprint information of the first user or retinal information of the first user.

7. A system for authorizing payment comprising:
a platform control system, coupled to the Internet, to authorize a transaction including:
receiving a first user credential;
receiving a first mobile number associated with a first user mobile device;
receiving at least one of a first SIM information associated with the first user mobile device or a first device verification code (DVC) associated with the first user mobile device;
receiving transaction details associated with the transaction;
receiving a first payment instrument identifier from a group of two or more payment instruments identifiers;
authorizing the first user by verifying that at least one of the first SIM information or the first DVC is associated with the first user credential;
transmitting information about the authorized first user, the first payment instrument identifier and the transaction details to an issuer associated with the first payment instrument identifier;
receiving an authorization of the transaction from the issuer.

8. The system of claim 7, wherein said platform control system transmits the authorization of the transaction to the first user mobile device.

9. The system of claim 7, further comprising the first mobile device.

10. The system of claim 7, wherein authorizing the first user includes:
receiving biometric information; and
verifying that the biometric information is associated with the first user.

11. The system of claim 7, further comprising registering the first user including:
receiving first user credential information from the first user mobile device associated with a first mobile number;
transmitting an account verification request;
receiving an account verification response in response to the account verification request;
receiving the first SIM information; and
associating the first SIM information, the first mobile number and the first user credential information.

12. The system of claim 11, wherein first user credential information at least two of a first user email address, a first user personal identification number, a first user biometric information.

13. The system of claim 12, wherein the first user biometric information includes at least one of fingerprint information of the first user or retinal information of the first user.

14. The system of claim 13, wherein said first user biometric information is captured by the first user mobile device.
